(19) United States
(12) Patent Application Publication
(10) Pub. No.: US 2020/0156154 A1
(43) Pub. Date: May 21, 2020

(54) PROCESS FOR MANUFACTURING AN ALUMINUM ALLOY PART

(71) Applicant: C-TEC Constellium Technology Center, Voreppe (FR)

(72) Inventors: Bechir CHEHAB, Voiron (FR); Bernard BES, Seyssins (FR); Christophe CHABRIOL, Champier (FR); Marine LEDOUX, Grenoble (FR); Thierry ODIEVRE, Voiron (FR)

(21) Appl. No.: 16/604,527

(22) PCT Filed: Apr. 5, 2018
(86) PCT No.: PCT/FR2018/050854

§ 371 Date: Oct. 10, 2019

(30) Foreign Application Priority Data
Apr. 14, 2017 (FR) 17/53315

(51) Int. Cl. B22F 7/00; C22C 1/04; C22F 1/057; B22F 3/105; B23K 15/00; B23K 26/00; C22C 21/16; B22F 3/15; B23K 26/342; B23K 35/02; B33Y 70/00; B22F 3/24; B33Y 80/00

(52) U.S. Cl. CPC B22F 7/008; C22C 1/0416; C22F 1/057; B22F 3/1055; B23K 15/0086; B23K 26/0006; B33Y 80/00; B22F 3/15; B23K 26/342; B23K 35/0261; B22F 2998/10; B33Y 70/00; B22F 2003/248; C22C 21/16

(57) ABSTRACT

The present invention relates to a process for manufacturing a part (20) comprising a formation of successive metal layers (20₁ . . . 20ₙ), superimposed on one another, each layer describing a pattern defined from a numerical model, each layer being formed by the deposition of a metal (15, 25), referred to as a filling metal, the filling metal being subjected, at a pressure greater than 0.5 times the atmospheric pressure, to an input of energy so as to melt and constitute said layer, the process being characterized in that the filling metal is an aluminium alloy of the 2xxx series, comprising the following alloying elements:
Cu, in a weight fraction of between 3% and 7%;
Mg, in a weight fraction of between 0.1% and 0.8%;
at least one element, or at least two elements or even at least three elements chosen from:
   Mn, in a weight fraction of between 0.1% and 2%, preferably of at most 1% and in a preferred manner of at most 0.8%;
   Ti, in a weight fraction of between 0.01% and 2%, preferably of at most 1% and in a preferred manner of at most 0.3%;
   V, in a weight fraction of between 0.05% and 2%, preferably of at most 1% and in the preferred manner of at most 0.3%;
   Zr, in a weight fraction of between 0.05% and 2%, preferably of at most 1% and in a preferred manner of at most 0.3%;
   Cr, in a weight fraction of between 0.05% and 2%, preferably of at most 1% and in the preferred manner of at most 0.3%; and
optionally at least one element, or at least two elements or even at least three elements chosen from:
   Ag, in a weight fraction of between 0.1% and 0.8%;
   Li, in a weight fraction of between 0.1% and 2%, preferably 0.5% and 1.5%;
   Zn, in a weight fraction of between 0.1% and 0.8%.

### TECHNICAL FIELD

The technical field of the invention is a method for manufacturing an aluminium alloy part, implementing an additive manufacturing technique.

### PRIOR ART

Additive manufacturing techniques have been developing since the 1980s. These techniques consist of forming a part by adding material, as opposed to machining techniques, which aim to remove material. Formerly confined to prototyping, additive manufacturing is now operational in the serial manufacture of industrial products, including metal parts.

The term “additive manufacturing” is defined according to the French standard XP E67-001 as a “set of processes making it possible to manufacture, layer by layer, by adding material, a physical object from a digital object”. Standard ASTM F2792 (January 2012) also defines additive manufacturing. Different additive manufacturing methods are also defined and described in standard ISO/ASTM 17296-1. The use of additive manufacturing to produce an aluminium part with low porosity has been described in the patent document WO2015/006447. The application of successive layers is generally carried out by applying a so-called filler material, then by melting or sintering the filler material using a laser beam, electron beam, plasma torch or electric arc type energy source. Whatever the additive manufacturing method applied, the thickness of each added layer is equal to about several tens or hundreds of microns.

Other publications describe the use of aluminium alloys as a filler material in the form of a powder or wire. The publication by Gu J. “Wire-Arc Additive Manufacturing of Aluminium” Proc. 25th Int. Solid Freeform Fabrication Symp., August 2014, University of Texas, 451-458, describes an example of the application of an additive manufacturing method referred to as WAAM, the acronym for “Wire +Arc Additive Manufacturing” on aluminium alloys for producing low porosity parts for the aeronautical field. The WAAM method is based on arc welding. It consists of stacking different layers successively on top of one other, each layer corresponding to a weld bead formed from a wire. This method makes it possible to obtain a relatively large cumulative weight of deposited material of up to 3 kg/h. When this method is carried out using an aluminium alloy, the latter is generally a 2319-type alloy. The Fixter publication “Preliminary Investigation into the Suitability of 2xxx Alloys for Wire-Arc Additive Manufacturing” studies the mechanical properties of parts manufactured using the WAAM method from a plurality of aluminium alloys. More particularly, with the copper content being maintained between 4 wt. % and 6 wt. %, the authors varied the magnesium content and digitally simulated the hot cracking susceptibility of 2xxx alloys during the WAAM method. The authors concluded that the optimum magnesium content is 1.5%, and that the aluminium alloy 2024 is particularly suitable. The authors did not recommend the use of a 2139-type aluminium alloy in additive manufacturing methods.

Other publications describe the use of specific aluminium alloys as a filler material. Patent document WO2016/145382 filed by Alcoa discloses an aluminium-based material having a high volume percent (1 to 30 vol. %) of at least one ceramic phase. The material thus disclosed in particular contains a high quantity of titanium (about 3%). Additionally, patent document WO2016/142631 filed by Microturbo discloses a material used to form a compressor, which material has an A20X™ alloy base in particular comprising 3.17% titanium. Finally, patent document EP3026135 filed by Ind. Tech. Res. Inst. discloses a method for manufacturing a part by additive manufacturing using alloys predominantly comprising silicon.

The document by Brice C. entitled “Precipitation behavior of aluminum alloy 2139 fabricated using additive manufacturing” Material Science and Engineering 648 (2015) 9-14, hereinafter referred to as Brice 2015, discloses the use of an additive manufacturing method, wherein the filler metal is formed by a wire exposed to an electron beam in a vacuum chamber. In this document, parts are formed in the shape of a wall. In order to compensate for the effect of magnesium evaporation as a result of the low pressure, the alloy forming the filler metal contains excess magnesium. The parts thus formed have an acceptable hardness. However, owing to a too high variability in the magnesium content thereof, the mechanical performance levels can vary from one point of the part to another, and in particular as a function of the height of the wall formed. Such heterogeneity is not compatible with the requirements for certain technical fields, for example aeronautics.

Other methods of additive manufacturing can be used. Mention can be made, for example, in a non-limiting manner, of the melting or sintering of a filler material in the form of a powder. This can involve laser sintering or melting. The patent application US2017/0016096 discloses a method for manufacturing a part by localised melting obtained by exposing a powder to an energy beam of the electron beam or laser beam type. This method is also referred to by the acronyms SLM for “Selective Laser Melting” or “EBM” for “Electron Beam Melting”. The powder is formed by an aluminium alloy having a copper content that lies in the range 5 wt. % to 6 wt. %, with the magnesium content whereof lying in the range 2.5 wt. % to 3.5 wt. %.

The mechanical properties of the aluminium parts obtained by additive manufacturing depend on the alloy forming the filler metal, and more precisely on the composition thereof, as well as on the heat treatments applied. The inventors have determined an alloy composition which, when used in an additive manufacturing method, enables parts with remarkable mechanical performance levels to be obtained.

### DESCRIPTION OF THE INVENTION

A first purpose of the invention is to propose a method for manufacturing a part including a formation of successive solid metal layers, superimposed on one another, each layer describing a pattern defined from a numerical model, each layer being formed by the deposition of a metal, referred to as a filler metal, the filler metal being subjected to an input of energy so as to melt and constitute, by solidifying, said layer, the process being implemented at a pressure greater than 0.5 times the atmospheric pressure, the method being characterised in that the filler metal is an aluminium alloy of the 2xxx group, comprising the following alloying elements:
Cu, the weight fraction whereof lies in the range 3 wt. % to 7 wt. %;
Mg, the weight fraction whereof lies in the range 0.1 wt. % to 0.8 wt. %;
at least one element, or at least two elements or even at least three elements chosen from:
   Mn, the weight fraction whereof lies in the range 0.1 wt. % to 2 wt. %, preferably at most 1 wt. % and in a preferred manner at most 0.8 wt. %;
   Ti, the weight fraction whereof lies in the range 0.01 wt. % to 2 wt. %, preferably at most 1 wt. % and in a preferred manner at most 0.3 wt. %;
   V, the weight fraction whereof lies in the range 0.05 wt. % to 2 wt. %, preferably at most 1 wt. % and in a preferred manner at most 0.3 wt. %;
   Zr, the weight fraction whereof lies in the range 0.05 wt. % to 2 wt. %, preferably at most 1 wt. % and in a preferred manner at most 0.3 wt. %;
   Cr, the weight fraction whereof lies in the range 0.05 wt. % to 2 wt. %, preferably at most 1 wt. % and in a preferred manner at most 0.3 wt. %; and
optionally at least one element, or at least two elements or even at least three elements chosen from:
   Ag, the weight fraction whereof lies in the range 0.1 wt. % to 0.8 wt. %;
   Li, the weight fraction whereof lies in the range 0.1 wt. % to 2 wt. %, preferably in the range 0.5 wt. % to 1.5 wt. %;
   Zn, the weight fraction whereof lies in the range 0.1 wt. % to 0.8 wt. %.

Such a magnesium content enables cracking risks to be limited. It should be noted that the magnesium content is in particular less than that disclosed in the patent application US2017/0016096. The inventors have estimated that a too high magnesium content leads to a risk of cracking, which is incompatible with the requirements of certain applications, for example in the aeronautics industry. This is why the magnesium content is preferably, in terms of weight fraction, no more than 0.8 wt. % and in a preferred manner no more than 0.6 wt. %.

The Mn, Ti, V, Zr and Cr elements can result in the formation of dispersoids or thin intermetallic phases enabling the hardness of the material obtained to be increased.

The Cu, Mg, Zn and Li elements can act on the strength of the material by precipitation hardening or by the effect thereof on the properties of the solid solution.

The alloy can further include at least one of the following elements:
Fe, the weight fraction whereof is at most 0.8 wt. %;
Si, the weight fraction whereof is at most 1 wt. %.

These two elements are often considered to be impurities when manufacturing parts according to conventional manufacturing methods from an alloy obtained by casting. It is generally accepted that these two elements are capable of deteriorating the mechanical properties of the parts manufactured in this way, in particular the ductility or strength thereof. The use of additive manufacturing-type manufacturing methods allows higher contents of these elements to be tolerated, without deteriorating the mechanical properties of the manufactured parts. In one embodiment, the minimum weight fraction of Fe and Si is 0.05 wt. % and preferably 0.1 wt. %.

Optionally, at least one element can be added, chosen from Co, Ni, W, Nb, Ta, Y, Yb, Nd, Er, Hf, La, and Ce, the content whereof is at most 2 wt. % so as to form additional dispersoids.

The material includes a weight fraction of other elements or impurities of less than 0.05 wt. %, i.e. 500 ppm. The cumulative weight fraction of the other elements or impurities is less than 0.15 wt. %.

In one embodiment of the invention, the 2xxx group alloy is chosen from AA2022, AA2050, AA2055, AA2065, AA2075, AA2094, AA2095, AA2195, AA2295, AA2395, AA2098, AA2039, and AA2139, and is preferentially chosen from AA2075, AA2094, AA2095, AA2195, AA2295, AA2395, AA2039, and AA2139.

The weight fraction of Cu can advantageously lie in the range 4 wt. % to 6 wt. %.

It is understood according to the present invention that the filler metal is used to the exclusion of any ceramic phase. Thus, preferably, the filler metal does not include any ceramic phase.

The term “2xxx group aluminium alloy” is understood according to the present invention to mean an alloy as described in the document “Registration Record Series—Teal Sheets—International Alloy designations and Chemical Composition Limits for Wrought Aluminum and Wrought Aluminum Alloys”, The Aluminum Association, February 2009 (revised January 2015). This document is a reference document in the field of aluminium alloys and is well known to a person skilled in the art in this field. It in particular specifies on page 28 thereof that the major alloying element of aluminium alloys in the 2xxx group is copper. On the other hand, pages 2 to 4 of this document give the limits for the different elements of this type of alloy and specify that the remainder of the composition of the alloys is aluminium. More specifically, it is customary in the field of aluminium alloys to only give the quantities of non-aluminium elements, it being understood that the quantity of aluminium makes up the remainder of the composition. Moreover, the aluminium alloys can contain impurities, which are generally present in quantities of up to 0.05 wt. % each and up to 0.15 wt. % in total.

According to one embodiment, the method can include, after the formation of the layers:
solution heat treatment followed by quenching and aging, or
heat treatment generally at a temperature of at least 100° C. and at most 400° C.,
and/or hot isostatic compression (HIP).

Heat treatment can in particular enable the residual stresses to be dimensioned, and/or additional precipitation of the hardening phases.

HIP treatment can in particular enable the elongation properties and fatigue properties to be improved. Hot isostatic compression can be carried out before, after or instead of the heat treatment.

According to one embodiment, the method includes, after the formation of the layers, hot isostatic compression followed by aging, or followed by solution heat treatment, quenching then aging.

Advantageously, hot isostatic compression is carried out at a temperature that lies in the range 250° C. to 550° C., preferably in the range 300 to 450° C., at a pressure that lies in the range 500 to 3,000 bar and for a duration that lies in the range 1 to 10 hours.

According to one embodiment, the method includes quenching, solution heat treatment and aging, wherein cold working is carried out between the quenching and aging steps.

Advantageously, solution heat treatment is carried out at a temperature that lies in the range 400 to 550° C. and quenching is carried out with a liquid containing water. Preferably, aging is carried out at a temperature that lies in the range 130° C. to 170° C.

Optionally, mechanical deformation of the part can be carried out at a stage of the manufacturing method, for example after additive manufacturing and/or before heat treatment.

According to another embodiment, adapted to age hardening alloys, solution heat treatment can be carried out, followed by quenching and aging of the part formed and/or hot isostatic compression. Hot isostatic compression can, in such a case, advantageously replace the solution heat treatment. However, the method according to the invention is advantageous since it preferably does not require any solution heat treatment followed by quenching. The solution heat treatment can be detrimental to the mechanical strength in certain cases by contributing to the magnification of the dispersoids or thin intermetallic phases.

According to one embodiment, the method according to the present invention optionally further includes machining treatment, and/or chemical, electrochemical or mechanical surface treatment, and/or tribofinishing. These treatments can be carried out in particular in order to reduce roughness and/or improve corrosion resistance and/or improve resistance to fatigue crack growth.

Optionally, mechanical deformation of the part can be carried out at a stage of the manufacturing method, for example after additive manufacturing and/or before heat treatment.

According to one embodiment, the filler metal takes on the form of a wire, exposure whereof to an electric arc results in localised melting of the alloy followed by solidification, so as to form a solid alloy layer. According to another embodiment, the filler metal takes on the form of a powder, exposure whereof to a laser beam results in localised melting of the alloy followed by solidification, so as to form a solid layer.

According to one embodiment, the method is implemented at ambient atmospheric pressure.

A second purpose of the invention is to propose a metal part, obtained after application of a method according to the first purpose of the invention.

A third purpose of the invention is to propose a metal powder or wire comprising, preferably consisting of, an aluminium alloy of the 2xxx group, comprising at least the following alloying elements:
Cu, the weight fraction whereof lies in the range 3 wt. % to 7 wt. %;
Mg, the weight fraction whereof lies in the range 0.1 wt. % to 0.8 wt. %;
at least one element, or at least two elements or even at least three elements chosen from:
   Mn, the weight fraction whereof lies in the range 0.1 wt. % to 2 wt. %, preferably at most 1 wt. % and in a preferred manner at most 0.8 wt. %;
   Ti, the weight fraction whereof lies in the range 0.01 wt. % to 2 wt. %, preferably at most 1 wt. % and in a preferred manner at most 0.3 wt. %;
   V, the weight fraction whereof lies in the range 0.05 wt. % to 2 wt. %, preferably at most 1 wt. % and in a preferred manner at most 0.3 wt. %;
   Zr, the weight fraction whereof lies in the range 0.05 wt. % to 2 wt. %, preferably at most 1 wt. % and in a preferred manner at most 0.3 wt. %;
   Cr, the weight fraction whereof lies in the range 0.05 wt. % to 2 wt. %, preferably at most 1 wt. % and in a preferred manner at most 0.3 wt. %; and
optionally at least one element, or at least two elements or even at least three elements chosen from:
   Ag, the weight fraction whereof lies in the range 0.1 wt. % to 0.8 wt. %;
   Li, the weight fraction whereof lies in the range 0.1 wt. % to 2 wt. %, preferably in the range 0.5 wt. % to 1.5 wt. %;
   Zn, the weight fraction whereof lies in the range 0.1 wt. % to 0.8 wt. %.

Preferably, the wire or powder according to the third purpose of the invention is characterised in that it is a filler metal for additive manufacturing or welding.

Other advantages and features will more clearly emerge from the following description and non-limiting examples, shown in the figures listed below.

### FIGURES

FIG. 1A is a diagram showing an additive manufacturing method of the WAAM type. FIG. 1B is a photograph of a wall produced according to the method shown with reference to FIG. 1A. FIG. 1C is a diagram showing the wall illustrated in FIG. 1B.

FIG. 2A shows comparative hardness tests conducted on wall-shaped parts manufactured by the WAAM method from different alloys, the parts having undergone different treatments after the additive manufacturing step.

FIG. 2B illustrates the evolution, along a transverse axis Z, in the hardness of wall-shaped parts obtained by the WAAM method from aluminium 2139 type alloys respectively with and without implementing a heat treatment resulting in the T6 temper.

FIG. 2C shows the evolution of the yield strength and tensile strength on test pieces derived from wall-shaped parts formed by WAAM from different alloys, the parts having undergone different treatments after the additive manufacturing step.

FIG. 2D shows the evolution in the elongation at rupture of parts formed by WAAM from different alloys, the parts having undergone different treatments after the additive manufacturing step.

FIG. 2E shows fatigue strengths determined during fatigue tests on test pieces derived from wall-shaped parts obtained by the WAAM method from different alloys, the parts having undergone different treatments after the additive manufacturing step.

FIG. 2F shows comparative hardness tests conducted on wall-shaped parts manufactured by the WAAM method from different alloys.

FIG. 2G illustrates the evolution, along a transverse axis Z, in the hardness of wall-shaped parts obtained by the WAAM method from aluminium 2295 alloys.

FIG. 2H shows cross-sections of walls produced from aluminium 2295 alloys and having undergone different heat treatments.

FIG. 3A and 3B show test pieces respectively used in the tensile and fatigue tests.

FIG. 4A is a diagram showing an additive manufacturing method of the SLM type.

FIG. 4B shows hardness measurements for different cube-shaped parts produced by SLM, the parts having undergone different heat treatments after the additive manufacturing step.

### DETAILED DESCRIPTION OF THE INVENTION

In the description, unless stated otherwise:
the designation of the aluminium alloys is compliant with the nomenclature laid down by The Aluminum Association;
the designation of the tempers is compliant with standard NF EN 515 in force in April 2017;
The chemical element contents are denoted as a weight percentage and represent weight fractions.

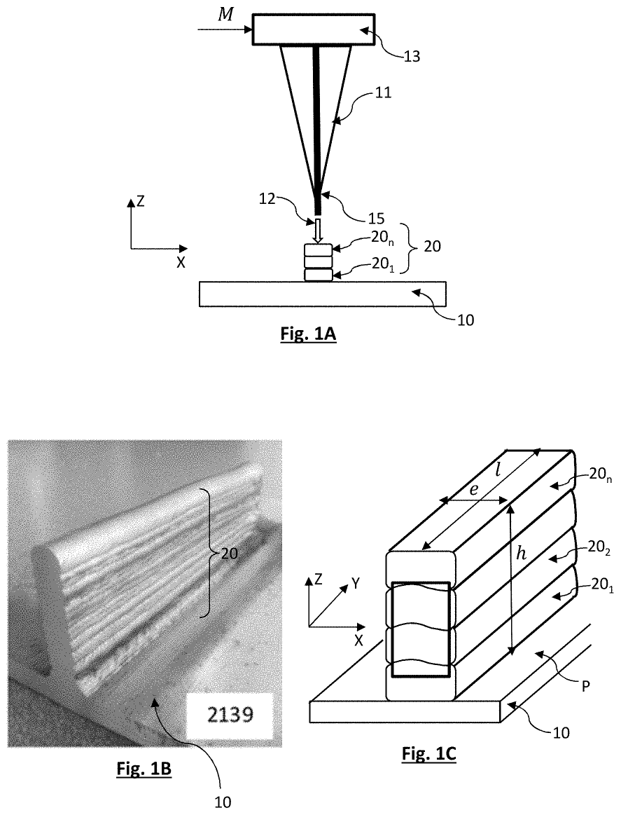

FIG. 1A shows an additive manufacturing device of the WAAM type, the acronym of “Wire +Arc Additive Manufacturing”. An energy source 11, in this case a torch, forms an electric arc 12. In this device, the torch 11 is supplied by an inert gas welding power source. The torch 11 is maintained by a welding robot 13. The part 20 to be manufactured is placed on a support 10. In the embodiment described in FIG. 1A, the manufactured part is a wall extending along a transverse axis Z perpendicular to a longitudinal plane XY defined by the support 10. Under the effect of the electric arc 12, a filler wire 15, in this case forming an electrode of the torch 11, melts to form, by solidifying, a weld bead. The welding robot is controlled by a numerical model M, and is displaced so as to form different layers 20₁ . . . 20ₙ, stacked on top of one another, forming the wall 20, each layer corresponding to a weld bead. Each layer 20₁ . . . 20ₙ extends in the longitudinal plane XY according to a pattern defined by the numerical model M. FIG. 1B is a photograph of a wall formed in this way. FIG. 1C is a diagrammatic representation of the wall 20 which extends, along the longitudinal plane XY, in thickness e and in length 1, and along the transverse axis Z, in height h relative to the support 10.

The method according to the invention is implemented at a pressure that is 0.5 times greater than atmospheric pressure. Thus, unlike the method described in Brice 2015, the Mg content remains high and controlled, which explains the high hardness measured on the wall manufactured from the alloy 2139. Moreover, during the implementation of a T6 treatment, the inventors consider that the controlled Mg and Ag contents of the alloy 2139 allows the best mechanical properties to be obtained owing to a precipitation of the Q phase in the dense planes {111}. Moreover, work at a pressure greater than 0.5 times atmospheric pressure, and advantageously at around atmospheric pressure enables parts to be obtained by additive manufacturing, the mechanical properties of which parts are homogeneous. The term “around atmospheric pressure” is understood according to the present invention to preferably mean between 80% and 120% atmospheric pressure.

The inventors attribute the remarkable properties, in particular in terms of mechanical strength, elongation and fatigue properties, to the homogeneity of the Mg content. Operations at atmospheric pressure enable the Mg content to be better controlled, as well as the homogeneity thereof in the parts manufactured by additive manufacturing. This is a particularly important point for applications such as those in the aeronautics field.

Advantageously, the method according to the invention includes, after the formation of the layers, a solution heat treatment followed by quenching and aging, in particular to obtain a T6 temper. The T6 treatment in particular enables the hardness to be significantly increased, this increase being advantageously at least 50% and preferably at least 60%.

According to one embodiment, the HIP treatment can be carried out before solution heat treatment, or instead of solution heat treatment. HIP treatment in particular enables the elongation properties and fatigue properties to be improved.

According to one embodiment, the method includes cold working between quenching and aging, cold working including, for example, modification of a dimension of the part that lies in the range 0.5% to 2%, or even 0.5% to 5%. The inventors have estimated that this enables, for example, an increase in hardness after aging treatment, which can in particular correspond to a T8 temper, and/or a reduction in the aging duration.

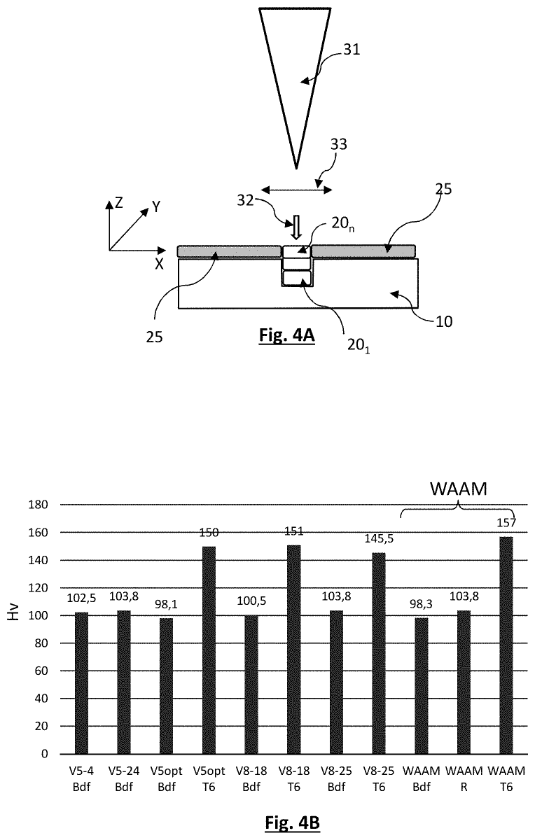

FIG. 4A shows another embodiment wherein the additive manufacturing method implemented is an SLM-type method (Selective Laser Melting). According to this method, the filler material 25 is present in the form of a powder. An energy source, in this case a laser source 31, emits a laser beam 32. The laser source is coupled to the filler material by an optical system 33, the movement whereof is determined as a function of a numerical model M. The laser beam 32 follows a movement along the longitudinal plane XY, describing a pattern that is dependent on the numerical model. The interaction of the laser beam 32 with the powder 25 causes selective melting of the latter, followed by solidification, resulting in the formation of a layer 20₁ . . . 20ₙ. When a layer has been formed, it is coated in powder 25 of the filler metal and another layer is formed, superimposed on the previously formed layer. The thickness of the powder forming a layer can, for example, lie in the range 10 to 100 μm.

The metal parts obtained after application of a method according to the invention advantageously have, in the T6 or T8 temper, a Vickers Hardness HV 0.1 of at least 150 and preferably at least 170 or even at least 180.

Advantageously, the metal parts obtained after applying a method according to the invention have, in the T6 or T8 temper, a yield strength R_{p0.2} of at least 400 MPa, preferably at least 410 MPa and preferably at least 420 Mpa, and/or an ultimate tensile strength Rₘ of at least 460 MPa and preferably at least 470 MPa and/or an elongation A % of at least 6% and preferably at least 8% and/or a fatigue strength at 10⁵ cycles of at least 240 Mpa and preferably at least 290 MPa.

### EXAMPLES

### Example 1

A plurality of filler wires 15 were used in order to manufacture different walls:
alloy 2319 wires corresponding to industrial welding wires;
alloy 2219 and 2139 wires obtained from cast prototype alloys, the wires being obtained by extrusion and wire drawing from billets having a diameter of 55 mm and a length of 150 mm.

In this example, the filler wire had a diameter of 1.2 mm. An inert gas welding power source available under the reference FK 4000-RFC by Fronius and a Motoman MA210 welding robot by Yaskawa were used.

The walls had a thickness e in the range 4 mm to 6 mm. The walls had a length l of 10 cm and a height h of 3 cm.

The parameters for the implementation of the WAAM method were as follows:
torch travel speed: 42 cm/min;
wire feed rate: in the range 5 to 9 m/min;
test conducted at atmospheric pressure.

The chemical composition of the walls was measured by mass spectrometry of ICP-OES type (inductively coupled plasma—optical emission spectrometry). The analysis results are provided in Table 1. Each result corresponds to a weight percentage. An analysis was conducted on each wall.

TABLE 1

| Alloy | Si | Fe | Cu | Mn | Mg | Ti | Ag | V | Zr |
|---|---|---|---|---|---|---|---|---|---|
| 2319 | 0.08 | 0.21 | 5.7 | 0.27 | <0.01 | 0.12 | <0.01 | 0.09 | 0.10 |
| 2219 | 0.04 | 0.10 | 6.3 | 0.29 | <0.01 | 0.03 | <0.01 | 0.12 | 0.17 |
| 2139 | 0.03 | 0.05 | 4.7 | 0.36 | 0.42 | 0.03 | 0.34 | <0.01 | <0.01 |

The WAAM walls obtained with the different alloys tested did not show any cracks or microcracks.

Moreover, analyses were also conducted on the filler wires 15. No noteworthy variation was observed as regards the composition between the filler wires and the walls respectively obtained from each filler wire.

Given that the alloys of the 2xxx group are capable of hardening by heat treatment, a so-called T6 treatment was carried out on the walls 20 so as to obtain a T6 temper. The treatment included a solution heat treatment (duration of 2 h—temperatures of 529° C. for 2139 and 542° C. for 2219 and 2319—temperature rise in stages of 40° C./h), quenching and aging (duration 25 h—temperature of 175° C. for 2219 and 2319—duration 15 h—temperature of 175° C. for 2139).

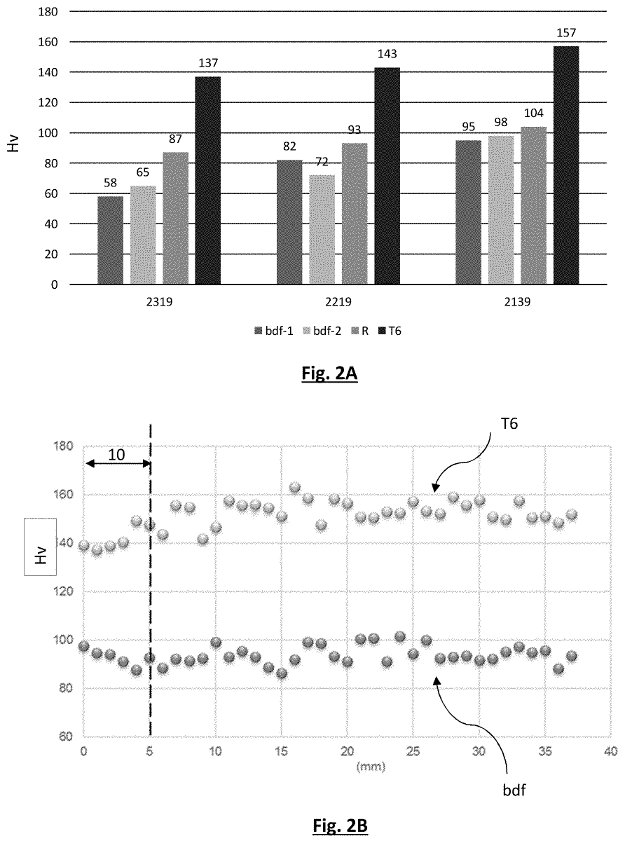

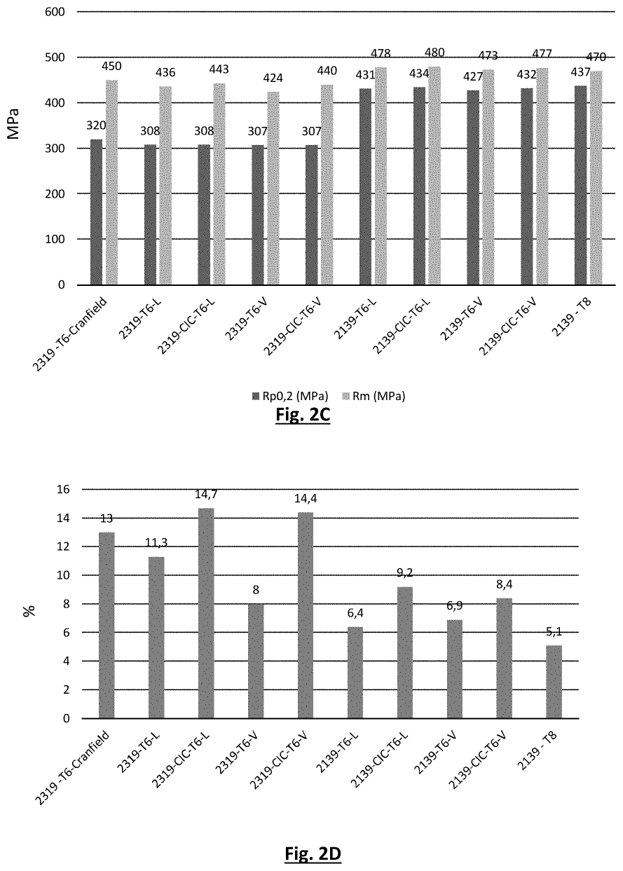

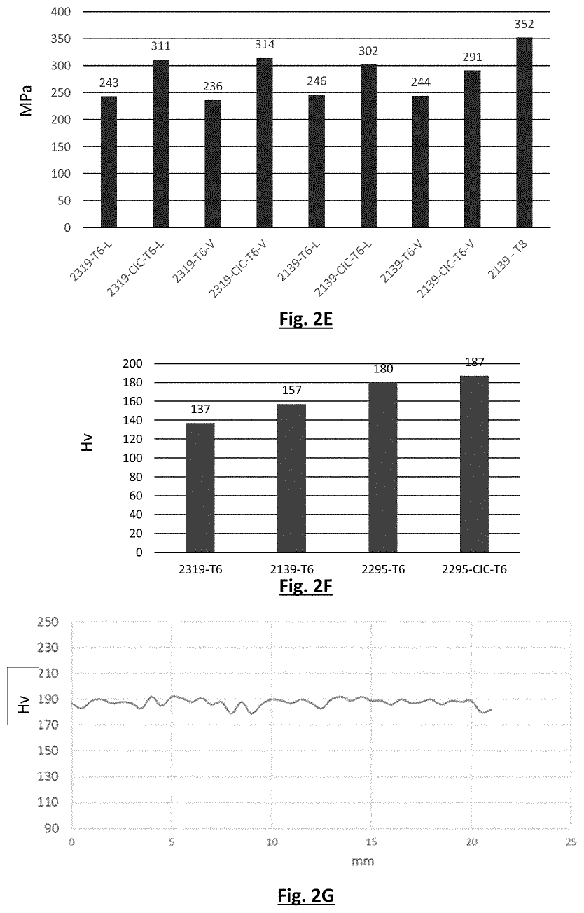

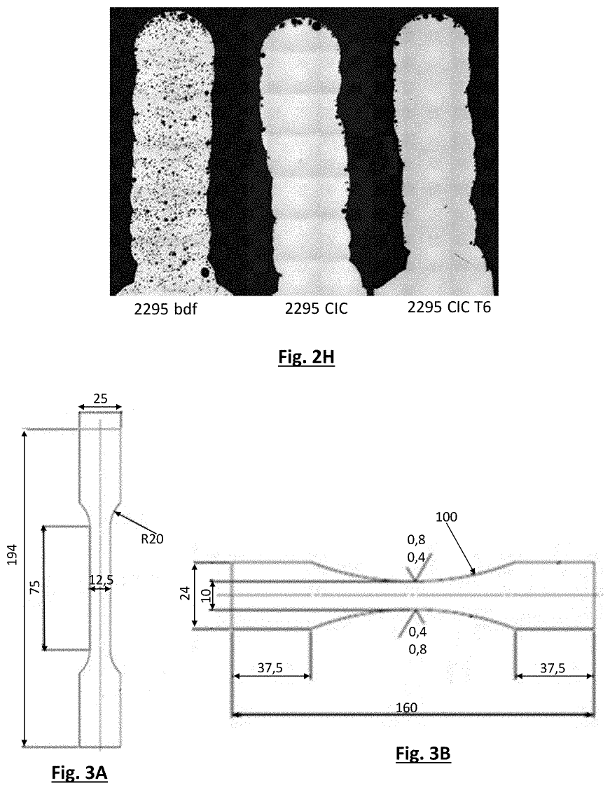

The Vickers Hardness HV 0.1 of the walls 20 was firstly characterised. The measurements were conducted according to standard NF EN ISO 6507-1. The results obtained are shown in FIG. 2A. This figure shows, for each alloy, from left to right, the hardness measured on the filler wire 15 (bdf-1), the wall produced as manufactured (bdf-2), the wall produced after aging (R), and the wall produced after T6 treatment. Each value shown in this figure corresponds to an average of 5 measurements. When the aging was carried out without solution heat treatment and quenching, the parameters (temperature, duration) were identical to those described in the paragraph hereinabove. The hardness obtained using the alloy 2139 is seen to be systematically greater than that of the walls obtained from the other alloys, and in particular alloy 2319, the latter being currently considered to be the alloy of reference for implementing the WAAM method. Moreover, the T6 treatment enables the hardness to be significantly increased, this increase being from about 50% to 60%.

Moreover, in order to ensure the spatial homogeneity of the hardness of the walls 20 obtained from the alloy 2139, a plurality of measurements of the Vickers Hardness HV 0.1 were carried out at different heights h, along the transverse axis Z. FIG. 2B shows the results obtained on walls that are respectively as manufactured (bdf), i.e. without any post-treatment, and with solution heat treatment, quenching and aging (T6 treatment). The abscissa represents the height h, expressed in mm, whereas the ordinate corresponds to the Vickers hardness measured. The abscissa 5 mm corresponds to the interface between the wall 20 and the support 10 (height equal to 0), materialised by a vertical dashed line. The abscissae less than 5 mm correspond to the support 10. Good homogeneity of the hardness was observed along the transverse axis Z for the two walls analysed. A significant increase in hardness was also observed under the effect of the T6 treatment applied to the wall, the increase being from about 50% to 60%. Obtaining homogeneous mechanical properties is a particularly interesting aspect compared to the method described in Brice 2015, which was implemented at a low pressure.

Thus, work carried out at a pressure exceeding 50% atmospheric pressure, and ideally at around atmospheric pressure, enables parts to be obtained by additive manufacturing, the mechanical properties of which parts are homogeneous. The term “around atmospheric pressure” is understood herein to preferably mean between 80% and 120% atmospheric pressure.

The results exposed in FIG. 2A and 2B show that the alloy 2139 is promising for the implementation of additive manufacturing techniques carried out at atmospheric pressure. Different walls were produced by WAAM based on this alloy, as well as alloy 2319, which is considered to be the alloy of reference. Test pieces were formed on each wall so as to carry out tensile and fatigue tests. The test pieces were sampled either along the transverse axis Z (test pieces V), or along the longitudinal axis Y parallel to the length l of each wall (test pieces H). The geometrical features of the test pieces depended on the tests conducted and will be described hereafter.

During these tests, the thickness e, the length l and the height h of each wall 20 were respectively equal to about 5 mm, about 440 mm and about 200 mm.

The walls were subjected to different heat treatments:
T6 treatment: solution heat treatment, quenching and aging so as to obtain the T6 temper. For 2319, solution heat treatment was carried out for 2 h at 542° C., and was preceded by a period in which the temperature was risen by 40° C./h. For 2319, solution heat treatment was carried out for 2 h at 529° C., and was preceded by a period in which the temperature was risen by 40° C./h. For each alloy, aging was carried out for 15 h at 175° C., and was preceded by a period in which the temperature was risen by 40° C./h.—
T6 treatment preceded by hot isostatic compression (HIP). For each alloy, the HIP parameters were a pressure and temperature rise over 2 hours from atmospheric pressure and ambient temperature, followed by a period of 2 hours at 497° C. and 1,000 bar.

FIG. 2C shows the yield strength Rp0.2 results (also referred to by the acronym YS) and tensile strength Rm results (also referred to by the acronym UTS for Ultimate Tensile Stress). The yield strength Rp0.2 corresponds to a relative elongation of the test piece by 0.2%. The test pieces implemented are “TOP C1” test pieces defined as per standard NF EN ISO 6892-1 and shown in

FIG. 3A. Each measurement corresponds to an average of the results obtained for 3 test pieces. The results obtained for each alloy were compared with measurements conducted on test pieces sampled from an industrial sheet metal made of 2139 alloy having undergone T8 treatment. The abscissa corresponds to the alloys used, the ordinate corresponds to the yield strength or tensile strength, measured in MPa. On each alloy, the left-hand bar quantifies the yield strength R_{p0.2} whereas the right-hand bar shows the ultimate tensile strength Rₘ. Letters H and V denote the axes along which the test pieces were sampled.

It can be seen that the yield strength and tensile strength are systematically greater when using alloy 2139 than when using alloy 2319, regardless of the treatment performed (T6 or HIP+T6), and in particular as regards the yield strength. The performance levels obtained with alloy 2139 are similar to those obtained using the industrial sheet metal (2139-T8).

The use of alloy 2139 results in increases to the yield strength and tensile strength respectively of about 40% and 10% relative to the walls formed using alloy 2319.

The reference 2319 T6 Cranfield corresponds to bibliographic data resulting from the publication by Gu Jianglong et al “The strengthening effect of inter-layer coldworking and post-deposition heat treatment on the additively manufactured Al-6.3Cu alloy”, Journal of Materials Processing Technology, 2016, 230, 26-34.

Moreover, images of cross-sections of walls were produced, for which a surface fraction of porosity was estimated using image processing software. It was seen that the HIP treatment carried out before the T6 treatment enables a low level of porosity, of less than 0.05%, to be obtained. Without HIP treatment, the porosity levels were in the vicinity of 0.5% with alloy 2139 and about 1.5% with alloy 2319, whereby T6 treatment was applied in each case. The T6 treatment was seen to enable the low porosity level obtained by implementing the HIP treatment to be preserved.

The use of HIP treatment had no significant effect on the yield strengths or tensile strengths observed. However, as shown in FIG. 2D, such a treatment enables the elongation to be increased to about 14.5% for alloy 2319 and about 9% for alloy 2139, regardless of the sampling direction (test pieces H or V). In FIG. 2D, the ordinate represents the relative elongation of the test pieces resulting from the tensile strength tests, expressed as a percentage.

Fatigue tests were conducted, using FPE 10 A test pieces as shown in FIG. 3B, according to standard NF EN ISO 6072. FIG. 2E shows the fatigue strength at 10⁵ cycles for different alloys.

Each value obtained is an average of 7 test pieces. Without HIP treatment, the average fatigue strength at 10⁵ cycles is about 240 Mpa with alloy 2319 and 245 Mpa with alloy 2139. The implementation of HIP treatment enables the average fatigue strength to be significantly increased, this value reaching 310 Mpa for alloy 2319 and 295 Mpa for alloy 2139.

The tests presented with reference to FIG. 2D and 2E show the relevance of HIP-type treatment applied prior to T6 treatment. FIG. 2C and 2D show significantly greater performance levels, in terms of yield strength or tensile strength, for the parts formed by additive manufacturing, at atmospheric pressure, using a 2139-type alloy compared to a 2319-type alloy.

### Example 2

Another series of tests was conducted using a filler material formed by a 2295 alloy. Walls 20 similar to those described hereinabove were produced again by implementing a WAAM method at atmospheric pressure. The chemical composition, in terms of weight percentage, of each wall was as follows:

TABLE 2

| Li | Si | Fe | Cu | Mn | Mg | Ti | Ag | V | Zr |
|---|---|---|---|---|---|---|---|---|---|
| 1.08 | 0.02 | 0.04 | 4.53 | 0.34 | 0.18 | 0.02 | 0.23 | <0.01 | 0.15 |

Measurements performed on the filler wire did not reveal any significant deviations between the composition of the filler wire and the walls formed therefrom.

The walls 20 then underwent T6 treatment or T6 treatment preceded by a hot isostatic compression (HIP) step. During the T6 treatment, solution heat treatment was carried out for 2 h at a temperature of 529° C. and aging was carried out for 100 h at a temperature of 160° C.

FIG. 2F shows the Vickers Hardness HV 0.1 values for the walls 20 obtained by implementing different alloys, these measurements having been performed according to standard NF EN ISO 6507-1. An average value of 5 measurements was calculated for each wall. FIG. 3A shows the average values calculated:
using an alloy 2319 as a filler material, with the wall then being subjected to T6 treatment as described hereinabove;
using an alloy 2139 as a filler material, with the wall then being subjected to T6 treatment as described hereinabove;
using an alloy 2295 as a filler material, with the wall then being subjected to T6 treatment according to the parameters stipulated in the previous paragraph;
using an alloy 2295 as a filler material, with the wall then being subjected to hot isostatic compression (2 hours at 497° C.—1000 bar) then T6 treatment.

The hardness of the wall formed from an alloy 2295 was seen to be clearly greater than that obtained with an alloy 2139. It was also seen that hot isostatic compression, before T6 solution heat treatment enables a hardness of 187 Hv to be obtained, that is to say an increase:
of about 20% relative to the hardness of a wall obtained from an alloy 2139 and having undergone T6 treatment;
of about 35% relative to the hardness of a wall obtained from an alloy 2319 and having undergone T6 treatment.

FIG. 2G shows a profile of the evolution in hardness according to the height of a wall produced with an alloy 2295, the wall having undergone HIP treatment before the T6 treatment. The ordinate represents the hardness, the abscissa represents the height along the Z axis. The hardness is seen to be spatially homogeneous.

FIG. 2H shows three cross-sections of walls produced so as to assess the porosity level, and more specifically a surface fraction of porosity. FIG. 2H shows, from left to right, cross-sections of a wall obtained from an alloy 2295, the wall being respectively as manufactured (bdf), having undergone HIP treatment and having undergone HIP treatment followed by T6 treatment (solution heat treatment, quenching and aging). On the wall as manufactured, the surface fraction of porosity was assessed to be 7%, which is attributed to a poor surface condition of the wire formed from the filler material. Hot isostatic compression enables the surface fraction of porosity to be reduced to 0.05%. The implementation of T6 treatment after HIP had no noteworthy effect on porosity.

These tests show that the alloy 2295 is particularly adapted to the manufacture of parts by additive manufacturing, and more particularly by implementing the WAAM method. Combination with HIP treatment and/or T6 treatment enables remarkable mechanical properties to be obtained.

### Example 3

In this example, walls were produced by the SLM method described hereinabove. In the following tests, the laser source 31 is a Nd/Yag laser with a power of 400 MW.

Cubic parallelepipeds of dimensions 1 cm×1 cm×1 cm were formed according to this method, by stacking different layers formed, the powder 25 being obtained from aluminium alloy 2139.

The composition of the powder was determined by ICP-OES and is given as a weight percentage in the following table.

TABLE 3

| Si | Fe | Cu | Mn | Mg | Ti | Ag | V | Zr |
|---|---|---|---|---|---|---|---|---|
| 0.04 | 0.09 | 4.8 | 0.29 | 0.39 | 0.05 | 0.34 | <0.01 | <0.01 |

A particle size analysis was conducted according to standard ISO 1332 using a Malvern 2000 particle size analyser. The curve describing the evolution in the volume fraction as a function of the diameter of the particles forming the powder describes a distribution similar to a Gaussian distribution. If d₁₀, d₅₀ and d₉₀ respectively represent the fractiles at 10%, at 50% (median) and at 90% of the distribution obtained, a rate of uniformity

$$σ = \frac{{d}_{90} - {d}_{10}}{{d}_{50}}$$

and a standard deviation

$$ɛ = \frac{{d}_{90}}{{d}_{10}}$$

can be defined. For the powder considered, σ=4.1±0.1% and ϵ=1.5±0.1% were measured. The values d₁₀, d₅₀ and d₉₀ were respectively 18.9 μm, 38.7 μm and 78 μm.

Different cubes were produced by UTBM (Université de Technologie de Belfort Montbéliard) while varying the experimental parameters linked to the power of the laser source 31 and the scanning speed of the beam 32 impacting the powder 25. The parameters are shown in Table 4. The first column corresponds to the references of each test. The second and third columns respectively correspond to the volume energy dissipated by the laser beam 32 and the scanning speed of the beam 32 at the surface of the powder.

TABLE 4

| | E (J/mm³) | V (m/min) |
|---|---|---|
| V5-4 | 167 | 40 |
| V5-24 | 194 | 30 |
| V5-opt | 194 | 25 |
| V8-18 | 1,600 | 5 |
| V8-25 | 255 | 23 |

Measurements were performed for the Vickers Hardness HV 0.1 either on so-called “as manufactured” walls (Bdf) not having undergone any treatment after the production thereof, or on walls having undergone T6 treatment, including solution heat treatment, quenching and aging, according to the parameters (temperature and duration) described hereinabove.

FIG. 4B shows the results obtained, with the Vickers Hardness HV 0.1 being shown as the ordinate. Each result is an average of 4 measurements. This figure also shows the Vickers Hardness HV 0.1 measurements respectively measured on walls manufactured by the WAAM method, respectively as manufactured, undergoing aging and undergoing T6 treatment.

For the as manufactured walls (Bdf), the hardness reached 100±10 Hv, which corresponds to the hardness obtained for walls manufactured by the WAAM method, as manufactured, or having undergone aging. The T6 treatment enabled the hardness to be significantly increased by about 60%, which is in accordance with the observation made with reference to FIG. 2B. The hardness obtained by SLM after T6 treatment was of the same order as that obtained by a wall formed by WAAM after T6 treatment.

1. Method for manufacturing a part including a formation of successive solid metal layers, superimposed on one another, each layer describing a pattern defined from a numerical model (M), each layer being formed by the deposition of a metal, referred to as a filler metal, the filler metal being subjected to an input of energy so as to melt and constitute, by solidifying, said layer, the process being implemented at a pressure greater than 0.5 times the atmospheric pressure, wherein the filler metal is an aluminium alloy of the 2xxx group, comprising at least the following alloying elements:
Cu, the weight fraction whereof lies in the range 3 wt. % to 7 wt. %;
Mg, the weight fraction whereof lies in the range 0.1 wt. % to 0.8 wt. %;
at least one element, or at least two elements or even at least three elements chosen from:
Mn, the weight fraction whereof lies in the range 0.1 wt. % to 2 wt. %, optionally at most 1 wt. % and in a preferred manner at most 0.8 wt. %;
Ti, the weight fraction whereof lies in the range 0.01 wt. % to 2 wt. %, optionally at most 1 wt. % and in a preferred manner at most 0.3 wt. %;
V, the weight fraction whereof lies in the range 0.05 wt. % to 2 wt. %, optionally at most 1 wt. % and in a preferred manner at most 0.3 wt. %;
Zr, the weight fraction whereof lies in the range 0.05 wt. % to 2 wt. %, optionally at most 1 wt. % and in a preferred manner at most 0.3 wt. %;
Cr, the weight fraction whereof lies in the range 0.05 wt. % to 2 wt. %, optionally at most 1 wt. % and in a preferred manner at most 0.3 wt. %; and
optionally at least one element, or at least two elements or even at least three elements chosen from:
Ag, the weight fraction whereof lies in the range 0.1 wt. % to 0.8 wt. %;
Li, the weight fraction whereof lies in the range 0.1 wt. % to 2 wt. %, optionally in the range 0.5 wt. % to 1.5 wt. %;
Zn, the weight fraction whereof lies in the range 0.1 wt. % to 0.8 wt. %.

2. Method according to claim 1, wherein the aluminium alloy further includes at least one of the following elements:
Si, the weight fraction whereof is at most 1 wt. %;
Fe, the weight fraction whereof is at most 0.8 wt. %.

3. Method according to claim 1, wherein the 2xxx group alloy is chosen from AA2022, AA2050, AA2055, AA2065, AA2075, AA2094, AA2095, AA2195, AA2295, AA2395, AA2098, AA2039, and AA2139, and is optionally chosen from AA2075, AA2094, AA2095, AA2195, AA2295, AA2395, AA2039, and AA2139.

4. Method according to claim 1, wherein the weight fraction of Cu lies in the range 4 wt. % to 6 wt. %.

5. Method according to claim 1, including, after formation of the layers, solution heat treatment followed by quenching and aging.

6. Method according to claim 5 including, between the quenching and aging, cold working.

7. Method according to claim 1, after formation of the layers, hot isostatic compression.

8. Method according to claim 1, wherein the filler metal takes on the form of a wire, exposure whereof to an electric arc results in localized melting followed by solidification, so as to form a solid layer.

9. Method according to claim 1, wherein the filler metal takes on the form of a powder, exposure whereof to a laser beam results in localized melting followed by solidification, so as to form a solid layer.

10. Metal part obtained by a method as claimed in claim 1.

11. Metal part according to claim 10 having in the T6 or T8 temper, by a Vickers Hardness HV 0.1 of at least 150 and optionally at least 170 or at least 180.

12. Metal powder or wire comprising, optionally consisting of, an aluminium alloy of the 2xxx group, comprising at least the following alloying elements:
Cu, the weight fraction whereof lies in the range 3 wt. % to 7 wt. %;
Mg, the weight fraction whereof lies in the range 0.1 wt. % to 0.8 wt. %;
at least one element, or at least two elements or even at least three elements chosen from:
Mn, the weight fraction whereof lies in the range 0.1 wt. % to 2 wt. %, optionally at most 1 wt. % and in a preferred manner at most 0.8 wt. %;
Ti, the weight fraction whereof lies in the range 0.01 wt. % to 2 wt. %, optionally at most 1 wt. % and in a preferred manner at most 0.3 wt. %;
V, the weight fraction whereof lies in the range 0.05 wt. % to 2 wt. %, optionally at most 1 wt. % and in a preferred manner at most 0.3 wt. %;
Zr, the weight fraction whereof lies in the range 0.05 wt. % to 2 wt. %, optionally at most 1 wt. % and in a preferred manner at most 0.3 wt. %;
Cr, the weight fraction whereof lies in the range 0.05 wt. % to 2 wt. %, optionally at most 1 wt. % and in a preferred manner at most 0.3 wt. %; and
optionally at least one element, or at least two elements or even at least three elements chosen from:
Ag, the weight fraction whereof lies in the range 0.1 wt. % to 0.8 wt. %;
Li, the weight fraction whereof lies in the range 0.1 wt. % to 2 wt. %, optionally in the range 0.5 wt. % to 1.5 wt. %;
Zn, the weight fraction whereof lies in the range 0.1 wt. % to 0.8 wt. %.

13. Wire or powder according to claim 12, further comprising a filler metal for additive manufacturing or welding.
